(19) United States
(12) Patent Application Publication
(10) Pub. No.: US 2009/0077584 A1
(43) Pub. Date: Mar. 19, 2009

(54) Methods, systems, and products for sharing presence information

(76) Inventors: Jay Oliver Glasgow, Acworth, GA (US); Brett D. Johnson, Acworth, GA (US); Laurence Siegel, Atlanta, GA (US); Charles Hart, Atlanta, GA (US)

Correspondence Address: AT&T Legal Department;Attn: Patent Docketing, Room 2A-207, One AT&T Way, Bedminster, NJ, 07921, US

(21) Appl. No.: 11/901,319

(22) Filed: Sep. 17, 2007

(51) Int. Cl. H04N 5/445

(52) U.S. Cl. 725/39

(57) ABSTRACT

Methods, systems, and products are disclosed for sharing presence information. Presence notifications are received from users, and the presence notifications describe content items currently being received by the users. A popularity of one or more of the content items being received by the users is determined. An electronic programming guide is provided that includes information regarding the one or more of the content items and the determined popularity associated with the one or more of the content items.

### NOTICE OF COPYRIGHT PROTECTION

A portion of this disclosure and its figures contain material subject to copyright protection. The copyright owner has no objection to the facsimile reproduction by anyone of the patent document or the patent disclosure, but otherwise reserves all copyrights whatsoever.

### BACKGROUND

This application generally relates to interactive video distribution systems and, more particularly, to monitoring users and to electronic program guides.

Electronic programming guides can be improved. Electronic programming guides have been used for many years by media providers. An electronic programming guide is usually a listing of television shows, movies, and other programming that is available from one or more media providers. The programming is usually chronologically arranged, and users may scroll the electronic programming guide and select programming of interest. Although electronic programming guides have been used for many years, their design has become stagnant. Conventional electronic programming guides have not changed, and many users feel electronic programming guides are boring. What is needed, then, are methods, systems, and products that compel users to utilize a new feature for electronic programming guides.

### SUMMARY

The exemplary embodiments describe methods, systems, and products for sharing presence information. Presence notifications are received from users, and the presence notifications describe content items currently being received by the users. A popularity of one or more of the content items being received by the users is determined. An electronic programming guide is provided that includes information regarding the one or more of the content items and the determined popularity associated with the one or more of the content items.

In another of the embodiments, a system is disclosed for sharing presence information. The system is operative to receive presence notifications from users. The presence notifications describe content items currently being received by the users. A popularity of one or more of the content items being received by the users is determined. An electronic programming guide is provided that includes information regarding the one or more of the content items and the determined popularity associated with the one or more of the content items.

In yet another embodiment, a computer program product is also disclosed for sharing presence information. The computer program product comprises a computer-readable medium storing computer code. This computer code causes receipt of presence notifications from users. The presence notifications describe content items currently being received by the users. A popularity of one or more of the content items being received by the users is determined. An electronic programming guide is provided that includes information regarding the one or more of the content items and the determined popularity associated with the one or more of the content items.

Other systems, methods, and/or computer program products according to the exemplary embodiments will be or become apparent to one with ordinary skill in the art upon review of the following drawings and detailed description. It is intended that all such additional systems, methods, and/or computer program products be included within this description, be within the scope of the claims, and be protected by the accompanying claims.

### BRIEF DESCRIPTION OF THE SEVERAL VIEWS OF THE DRAWINGS

These and other features, aspects, and advantages of the exemplary embodiments are better understood when the following Detailed Description is read with reference to the accompanying drawings, wherein:

FIG. 1 is a simplified schematic illustrating a network environment in which exemplary embodiments may be implemented;

FIG. 2 is a schematic illustrating shared presence information, according to exemplary embodiments;

FIG. 3 is a schematic further illustrating an electronic programming guide, according to more exemplary embodiments;

FIG. 4 is a schematic illustrating a process for sharing presence information, according to more exemplary embodiments;

FIG. 5 is a schematic illustrating a buddy presence notification, according to more exemplary embodiments;

FIG. 6 is a schematic illustrating another process for sharing presence information, according to still more exemplary embodiments;

FIG. 7 is a schematic illustrating yet another process for sharing presence information, according to still more exemplary embodiments;

FIGS. 8 and 9 are schematics illustrating yet another process for sharing presence information, according to even more exemplary embodiments;

FIG. 10 is a schematic further illustrating presence information, according to even more exemplary embodiments; add IM application as example of

FIG. 11 depicts other possible operating environments, according to more exemplary embodiments; and

FIG. 12 is a flowchart illustrating a method for presence information, according to more exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

The aforementioned problems, and other problems, are reduced, according to exemplary embodiments, using methods, systems, and products that share presence information. Exemplary embodiments employ the concept of “presence” to determine the popularity of content. That is, when a user selects a movie, program, game, or any other content, exemplary embodiments report that selection (e.g., channel and/or title and user identification) to a service provider. Exemplary embodiments may then determine how many users are watching/receiving/downloading the same channel or other content. Exemplary embodiments, for example, tabulate how many users are receiving, retrieving, or downloading content associated with a particular provider such as, but not limited to, CNN®, HBO®, ABC®, or any other aggregator. Exemplary embodiments may determine how many users are retrieving a webpage, such as www.espn.com, www.msnbc.com, or www.youtube.com. Exemplary embodiments, in fact, may determine how many users are retrieving/downloading any uniform resource locator (URL). If a user is watching a DVD or listening to music, exemplary embodiments may even report that content. Whatever the content or mode of operation, exemplary embodiments may determine the popularity of content.

Exemplary embodiments may then inform the users of each content's popularity. An electronic programming guide, for example, may be enhanced to list the popularity of each offered television show, movie, and other content. The electronic programming guide may list how many users are watching/receiving CNN®, TBS®, and BBC®. For example, if a movie on demand is offered, the electronic programming guide may be enhanced to display how many users are downloading the same movie. As a user scrolls the electronic programming guide, the user easily sees how many users are watching a particular content offering. Exemplary embodiments may thus create “peer-pressure” ratings, in which users may select and receive the same content to ensure a popular program is not missed.

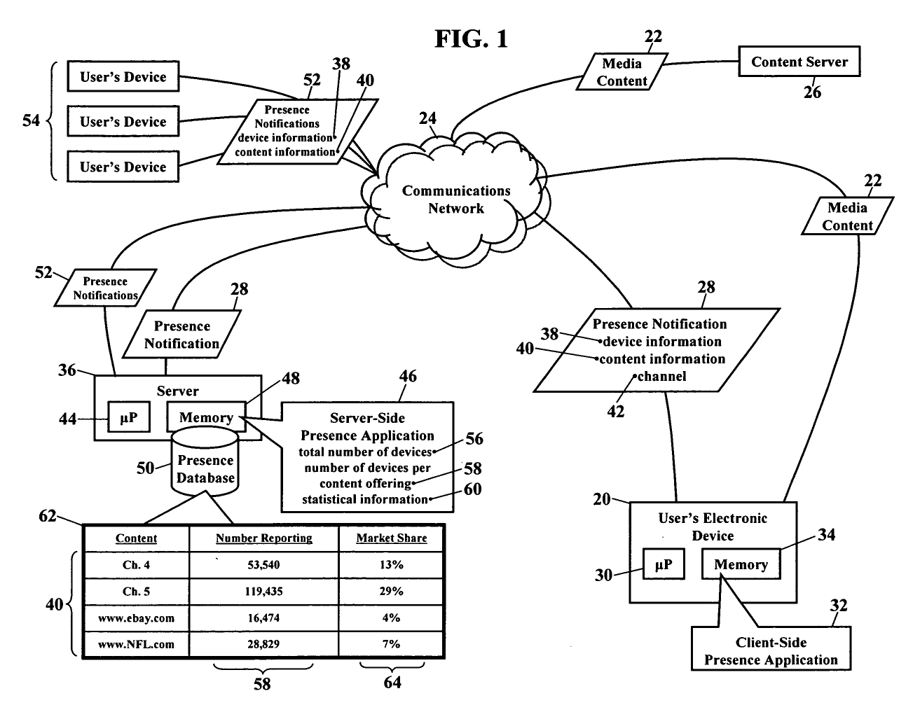

FIG. 1 is a simplified schematic illustrating a network environment in which exemplary embodiments may be implemented. A user's electronic device 20 receives a media content 22 from a communications network 24. The media content 22 may originate, or be received from, any source, such as a content server 26. The media content 22 may be any audio and/or video content, such as a movie, music, game, data, or television programming. The media content 22 may have any formatting, and the media content 22 may be streamed (e.g., unicast or multicast) or broadcast to the electronic device 20. Although the user's electronic device 20 is generically shown, the electronic device 20, as will be later explained, may be a computer, a radio, a set-top receiver, a personal digital assistant (PDA), a cordless/cellular/IP phone, digital music player, or any other processor-controlled device.

At any time the user's electronic device 20 may send a presence notification 28. The user's electronic device 20 comprises a user processor 30 (e.g., “μP”), application specific integrated circuit (ASIC), or other similar device that executes a client-side presence application 32 stored in memory 34. The client-side presence application 32 may comprise processor-executable instructions that report the presence of the user's electronic device 20. According to exemplary embodiments, the client-side presence application 32 causes the user processor 30 to send the presence notification 28 to a server 36. The presence notification 28 communicates via the communications network 24 to the server 36. As later paragraphs will explain, the presence notification 28 may be periodically sent and/or randomly sent. The presence notification 28 may be sent in response to receipt of the media content 22, and/or the presence notification 28 may be sent in response to a prompt, as later paragraphs will explain.

The presence notification 28 may identify the user's electronic device 20. The presence notification 28, for example, may include any information that describes, or indicates, the presence of the user's electronic device 20. The presence notification 28 may include device information 38 that uniquely describes the electronic device 20. The presence notification 28, for example, may describe a manufacturer, model number, serial number, or other information associated with the electronic device 20. The presence notification 28 may even describe a name, an account number, an address, a user's identification, or other unique information assigned to the user of the electronic device 20. The device information 38 may be assigned by a manufacturer, by a service provider, and/or by the user. The client-side presence application 32 collects or retrieves the device information 38 and reports to the server 36.

The presence notification 28 may also include content information 40. When the user's electronic device 20 receives the media content 22, the client-side presence application 32 may also report a description of the media content 22. When, for example, the media content 22 is a movie, the content information 40 may describe a title of the movie and/or a unique content identifier assigned to the movie. When the media content 22 is music, the content information 40 may describe a title of the music and/or a unique content identifier assigned to the music. When the media content 22 is grouped or associated with a channel designation, the content information 40 may describe a channel 42 currently being received by the electronic device 20. The content information 40 may additionally or alternatively describe actor/actress names, director/producer name, and/or a summary of the media content 22. When the media content 22 is a game or gaming application, the content information 40 may describe a game or gaming application, a title of the game, current players, roles, scores, and/or outcomes. When the media content 22 is a website or webpage (e.g., www.ebay.com or www.amazon.com), the content information 40 may describe a uniform resource locator, I.P. address, domain name, or other identifier of the website or webpage. The media content 22 may even be a distributed software application, and the content information 40 may describe the software application. The content information 40, in general, may be any identification number, title, code, information, or alphanumeric string that uniquely describes the media content 22. According to exemplary embodiments, whatever the media content 22, the content information 40 describes the media content 22 using as much detail as the service provider desires and/or the user cares to reveal. The client-side presence application 32 collects or retrieves the content information 40 and reports to the server 36.

The server 36 receives the presence notification 28. The server 36 comprises a processor 44 (e.g., “μP”), application specific integrated circuit (ASIC), or other similar device that executes a server-side presence application 46 stored in memory 48. The server-side presence application 46 may comprise processor-executable instructions that inspect the presence notification 28 for the device information 38 and/or for the content information 40. According to exemplary embodiments, when the presence notification 28 is received, the server-side presence application 46 extracts, reads, or otherwise obtains the device information 38 and/or the content information 40. The server-side presence application 46 may store the content information 40 in a presence database 50. The presence database 50 is illustrated as being locally stored in the memory 48 of the server 36, yet the presence database 50 may be remotely accessed via the communications network 24. The presence database 50 stores presence information for any, some, or all users. The presence database 50 may or may not associate the device information 38 to the content information 40, depending on privacy policies, service agreements, and/or licensing agreements. The server-side presence application 46 thus updates the presence database 50 with the content information 40 describing the media content 22 currently being received by the user's electronic device 20.

As FIG. 1 illustrates, the server 36 may receive additional presence notifications 52 from other users' devices 54. Each of the additional presence notifications 52 may include the device information 38 that uniquely describes each user's device 54. Each of the additional presence notifications 52 may also include the content information 40 that reports the media currently being received by each user's device 54. The server-side presence application 46 may query or poll for the additional presence notifications 52, and/or each user's device 54 may self-report. Regardless, the server-side presence application 46 is notified of the content currently being received by each user's device 54. The server-side presence application 46 updates the presence database 50 with the content information 40 describing the content currently being received by each user's device 54. The presence database 50 may thus store a complete table, listing, or log of devices and/or the content being received by each device.

The server-side presence application 46 may then determine popularities. Because the presence database 50 may store the content being received by each user's device 54, the server-side presence application 46 may count or tally how many users are currently receiving each offered content item. The server-side presence application 46, for example, may query the presence database 50 to determine how many devices are currently receiving a channel associated with HBO®, TBS®, CBS®, and/or any/all other channels. The server-side presence application 46 may query to determine how many devices are currently receiving/downloading the same website, streaming movie, or other content received from a uniform resource locator (URL). The server-side presence application 46 may query to determine how many devices are currently engaged in the same game or running the same gaming application. According to exemplary embodiments, the server-side presence application 46, in other words, counts or sums the number of devices receiving the same content. The server-side presence application 46 may determine a total number 56 of devices by summing the number of presence notifications received from different devices. The server-side presence application 46 may also determine the number 58 of users/devices receiving a particular content. The client-side presence application 32 and the server-side presence application 46, in general, may cooperate to calculate and/or accumulate real-time, instantaneous statistical information 60 on the number of users that are currently receiving a channel, a webpage, streaming video or music, or other content.

FIG. 1, for example, illustrates the statistical information 60 as a table 62 of content popularities. The table 62 of content popularities may be stored in the memory 48. The table 62 of content popularities maintains statistics on the popularity of content. The table 62 of content popularities, for example, tabulates or lists the content information 40 and the number 58 of devices currently reporting the content information 40. Because the server-side presence application 46 may know the total number 56 of devices, the server-side presence application 46 may calculate a market share, rating, or percentage 64 of devices reporting the content information 40. The server-side presence application 46 may thus maintain real-time statistics on the number of users that are currently receiving any offered content.

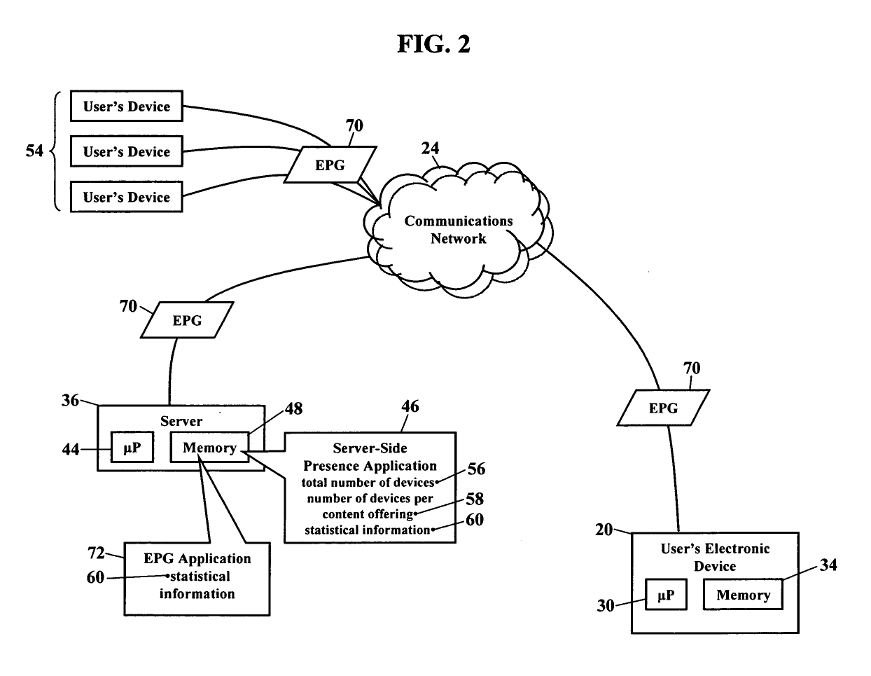

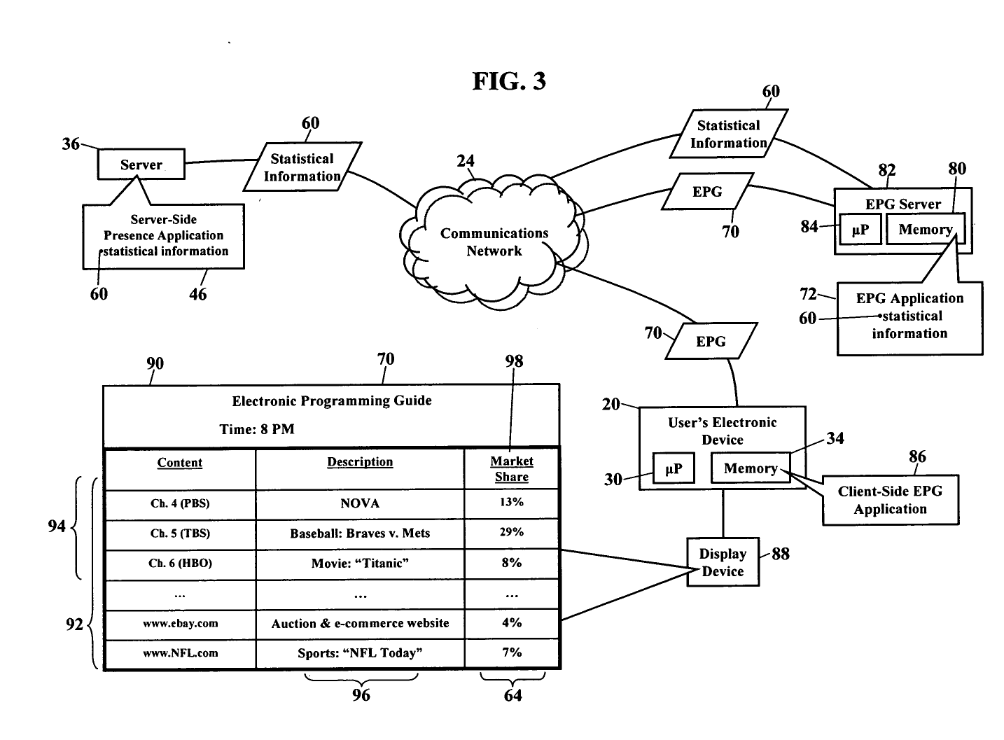

FIG. 2 is a schematic further illustrating shared presence information, according to exemplary embodiments. Here, once the server-side presence application 46 determines the real-time popularity of the offered content, the server-side presence application 46 then updates an electronic programming guide 70, according to exemplary embodiments. As those of ordinary skill in the art understand, the electronic programming guide 70 comprises a listing of content available from one or more service and/or content providers. The listing of content may or may not be chronologically arranged by provider. The server-side presence application 46 interfaces with an electronic programming guide (or “EPG”) application 72 that provides and/or generates the electronic programming guide 70. FIG. 2 illustrates the electronic programming guide application 72 as being stored in the memory 48 of the server 36. The electronic programming guide application 72, however, may operate in a dedicated EPG server (as FIG. 3 will illustrate). Regardless, the server-side presence application 46 shares the statistical information 60 with the electronic programming guide application 72, according to exemplary embodiments. The electronic programming guide application 72 then incorporates the statistical information 60 into the electronic programming guide 70. The electronic programming guide 70 may now describe the number of users that are currently receiving a channel, webpage, streaming video, or other content listed in the electronic programming guide 70. Whether the electronic programming guide 70 is streamed (e.g., unicast or multicast) or broadcast to the users' devices 54, the users now know the popularity of the available media. As a user scrolls the electronic programming guide 70, the user may succumb to peer-pressure. When a user sees content that is popular, the user may select and receive that same content to ensure a popular event is not missed.

Exemplary embodiments are applicable to any number of users. FIGS. 1 and 2, for simplicity, only illustrate four users (e.g., the user's electronic device 20 and the users' devices 54). Exemplary embodiments, however, may be used to share presence information with any number of users. Exemplary embodiments permit any number of users, no matter how many, to share/report real-time presence information with some or all other users.

FIG. 3 is a schematic further illustrating the electronic programming guide 70, according to more exemplary embodiments. Here the server-side presence application 46 operates in the server 36, while the electronic programming guide application 72 is stored in memory 80 of an EPG server 82. According to exemplary embodiments, the server-side presence application 46 sends the statistical information 60 to the electronic programming guide application 72. The statistical information 60 describes the popularity of one or more content items listed in the electronic programming guide 70. The electronic programming guide application 72 may instruct an EPG processor 84 to incorporate the statistical information 60 into the electronic programming guide 70. The EPG server 82 then distributes the electronic programming guide 70 to the user's electronic device 20. According to exemplary embodiments, the user's electronic device 20 comprises a client-side EPG application 86 stored in the memory 34. The client-side EPG application 86 may comprise processor-executable instructions that process the electronic programming guide 70 for visual and/or audible presentation. The client-side EPG application 86, for example, processes the electronic programming guide 70 for display on a display device 88.

The electronic programming guide 70 may include a graphical user interface 90. The graphical user interface 90 may provide a listing 92 of content available from one or more providers. The listing 92 of content is usually, but not necessarily, chronologically arranged. The listing 92 of content may also be sequentially arranged, perhaps according to a channel designation 94, although any arrangement is suitable. The listing 92 of content may also include a title and/or description 96 of each content offering. As FIG. 3 illustrates, though, the graphical user interface 90 is enhanced to provide statistical information for one or more offerings in the listing 92 of content. The electronic programming guide 70, for example, may include a popularity 98 of each content offering (e.g., the channel designation 94, website, or other URL). The popularity 98 of each content offering is illustrated as being expressed by the market share, rating, or percentage 64 of devices reporting the channel designation 94, website, or other content identifier. The graphical user interface 90, however, may alternatively or additionally express the popularity 98 as the raw number of devices receiving a particular content or channel (illustrated as reference numeral 58 in FIG. 1).

The electronic programming guide 70, then, may create “peer pressure” ratings. Because the electronic programming guide 70 displays the popularity 98 of each channel or content, viewers know how many people are receiving/watching a particular content offering. When a viewer notices a curious percentage of people watching a movie, for example, the viewer is more apt to select that same movie—even if the title and/or description 96 is not appealing. When content is appealing to significant numbers of viewers, additional viewers may succumb to “peer pressure” and not want to miss a popular event.

Exemplary embodiments may be incorporated into each content offering. As a user “surfs” channels or other offered content, the statistical information 60 may be displayed in a corner of the screen. In other words, as the user flips through channels, each channel may display its associated popularity. Here, then, the user need not consult the electronic programming guide 70 to obtain the popularity of a content offering. The server-side presence application 46, for example, may send the statistical information 60 to any media providers, aggregators, or producers. The server-side presence application 46, for example, may send the statistical information 60 to the content server 26. Because the statistical information 60 describes the popularity of channel, URL, or other content offering, the content server 26 may incorporate the statistical information 60 into the media content 22. That is, when the user's electronic device 20 receives the media content 22, the statistical information 60 may be encoded or embedded within the media content 22. The client-side presence application 32 may then process the statistical information 60 and present the statistical information 60 to the user. The client-side presence application 32 may process the statistical information 60 for display on the display device 88. As a user “surfs” channels or other offered content, the statistical information 60 may be displayed in a corner of the display device 88.

The electronic device 20, the server 36, and the EPG server 82 are only simply illustrated. Because the architecture and operating principles of computers, communications devices, and other processor-controlled devices are well known, details of the hardware and software components of these devices are not further shown and described. If, however, the reader desires more details, the reader is invited to consult the following sources: ANDREW TANENBAUM, COMPUTER NETWORKS (4^{th} edition 2003); WILLIAM STALLINGS, COMPUTER ORGANIZATION AND ARCHITECTURE: DESIGNING FOR PERFORMANCE (7^{th} edition 2005); and DAVID A. PATTERSON & JOHN L. HENNESSY, COMPUTER ORGANIZATION AND DESIGN: THE HARDWARE/SOFTWARE INTERFACE (3^{rd} Edition 2004).

Some aspects of presence and electronic programming guides are known, so this disclosure will not greatly explain the known details. If the reader desires more details, the reader is invited to consult the following sources: U.S. Pat. No. 5,592,551 to Lett, et al.; U.S. Pat. No. 5,630,119 to Aristides, et al.; U.S. Pat. No. 5,758,259 to Lawler; U.S. Pat. No. 5,781,246 to Alten, et al.; U.S. Pat. No. 6,130,726 to Darbee, et al.; U.S. Pat. No. 6,133,962 to Proehl, et al.; U.S. Pat. No. 6,219,839 to Sampsell; U.S. Pat. No. 6,421,067 to Kamen, et al.; U.S. Pat. No. 6,813,775 to Finseth, et al.; U.S. Patent Application Publication 2002/0053084 to Escobar, et al.; U.S. Patent Application Publication 2003/0084448 to Soundararajan; U.S. Patent Application Publication 2003/0115585 to Barsness, et al.; U.S. Patent Application Publication 2003/0135852 to Kamemoto; U.S. Patent Application Publication 2003/0163817 to Han; U.S. Patent Application Publication 2005/0149987 to Boccon-Gibod, et al.; U.S. Patent Application Publication 2006/0010470 to Kurosaki, et al.; U.S. Patent Application Publication 2006/0041904 to Lee; and U.S. Patent Application Publication 2006/0221173 to Duncan.

Exemplary embodiments may be applied regardless of networking environment. The communications network 24 may be a cable network operating in the radio-frequency domain and/or the Internet Protocol (IP) domain. The communications network 24, however, may also include a distributed computing network, such as the Internet (sometimes alternatively known as the “World Wide Web”), an intranet, a local-area network (LAN), and/or a wide-area network (WAN). The communications network 24 may include coaxial cables, copper wires, fiber optic lines, and/or hybrid-coaxial lines. The communications network 24 may even include wireless portions utilizing any portion of the electromagnetic spectrum and any signaling standard (such as the I.E.E.E. 802 family of standards, GSM/CDMA/TDMA or any cellular standard, and/or the ISM band, and/or satellite networks). The concepts described herein may be applied to any wireless/wireline communications network, regardless of physical componentry, physical configuration, or communications standard(s). Exemplary embodiments are also applicable to any television system and/or delivery mechanism. Exemplary embodiments may be applied to analog television, digital television, standard and/or high definition television, cable television network systems, and Internet Protocol television network systems.

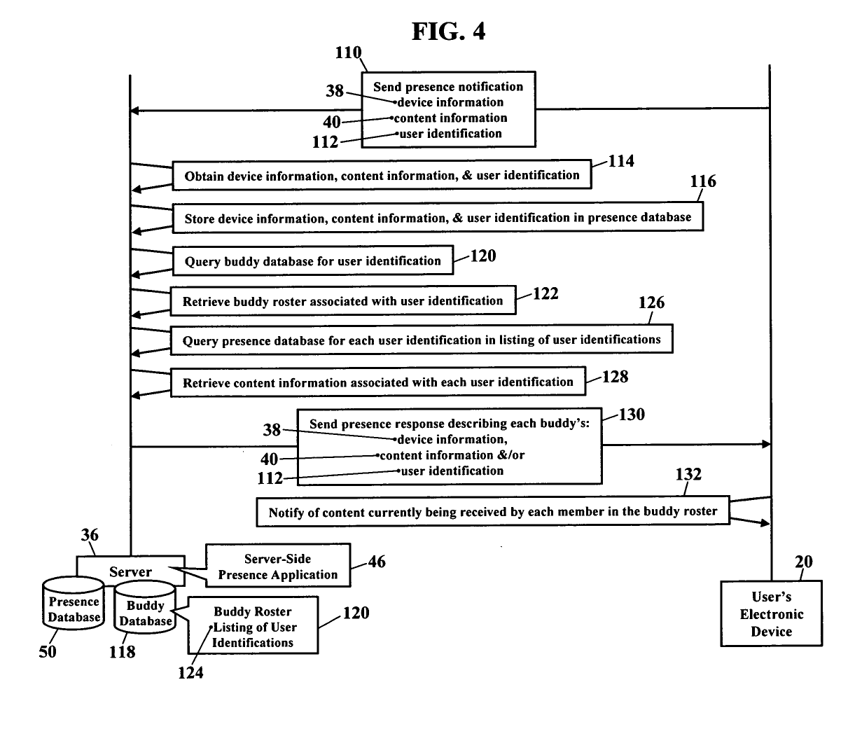

FIG. 4 is a schematic illustrating a process for sharing presence information, according to more exemplary embodiments. Here users may share their presence information with other users. The user's electronic device 20 sends the presence notification (Block 110). The presence notification communicates to the server 36 via the communications network (illustrated as reference numeral 24 in FIG. 1). The presence notification may include the device information 38 that uniquely describes the electronic device 20. The presence notification 28 may also report the content information 40 that describes the content currently being received by the user's electronic device 20. Here the presence notification 28 may also include a user identification 112 that uniquely identifies a user. The user identification 112, for example, may be a username, password, and/or personal identification number (PIN). The user identification 112, however, may be any alphanumeric designation that uniquely identifies the user from other users. The presence notification 28 may thus uniquely describe a device, the current user of that device, and/or the content being received by that device.

The server 36 receives the presence notification. The server-side presence application 46 may read, extract, or otherwise obtain the device information 38, the content information 40, and the user identification 112 (Block 114). The server-side presence application 46 may then store the device information 38, the content information 40, and the user identification 112 in the presence database 50 (Block 116). The presence database 50 is thus enhanced to track what users are associated with what devices and what content is currently being received by each device.

The server-side presence application 46 may then query a buddy database 118 for the user identification 112 (Block 120). The buddy database 118 associates user identifications to buddy rosters. One or more users may establish a buddy list or roster 120 that associates a group of users. When the server-side presence application 46 queries the buddy database 118, the server-side presence application 46 retrieves the buddy roster 120 associated with the user identification 112 (Block 122). According to exemplary embodiments, the buddy roster 120 comprises a listing 124 of user identifications that are associated with the user identification 112. The buddy roster 120, in other words, comprises members of a group, or “buddies,” that agree to share their presence information amongst the group.

Exemplary embodiments then obtain the content currently being received for each buddy. Once the buddy roster 120 is obtained, the server-side presence application 46 knows the listing 124 of user identifications associated with the user identification 112. The server-side presence application 46 may then query the presence database 50 for each user identification in the listing 124 of user identifications (Block 126). The server-side presence application 46 may thus retrieve the content information associated with each user identification 112 (Block 128). The server-side presence application 46 now knows what content is currently being received by each buddy.

The server-side presence application 46 sends a presence response (Block 130). The presence response communicates to the user's electronic device 20 via the communications network 24. The presence response includes information that describes or identifies the content being received by each member in the user's buddy roster 120. The presence response, for example, may include the device identification 38, the user identification 112, and/or the content information 40 associated with each member in the buddy roster. When the presence response is received, the client-side presence application 32 processes the presence response. The client-side presence application 32 may notify the user of the content currently being received by each member in the user's buddy roster 120 (Block 132). The user is thus informed of what content each buddy is currently receiving.

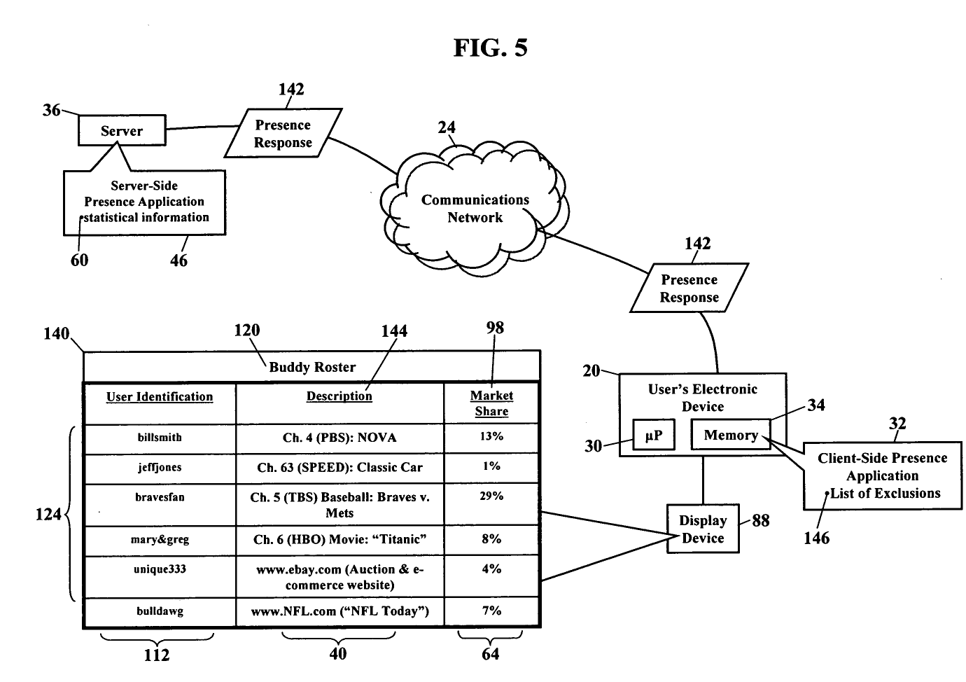

FIG. 5 is a schematic illustrating a buddy presence notification 140, according to more exemplary embodiments. When the user's electronic device 20 receives the presence response (illustrated as reference numeral 142), the client-side presence application 32 may process the presence response 142 for visual and/or for audible presentation. The client-side presence application 32, for example, may cause display of the buddy presence notification 140 on the display device 88. The buddy presence notification 140 may present the listing 124 of user identifications that are associated with the buddy roster 120. The buddy presence notification 140 may also present a description 144 of the content currently being received by each member in the user's buddy roster 120. The buddy presence notification 140 may simply present the user identification 112 and/or the content information 40 associated with each member in the buddy roster 120. The buddy presence notification 140 may also present the popularity 98 associated with the content being received by each buddy. FIG. 5 again expresses the popularity 98 as the market share, rating, or percentage 64 of devices reporting the associated content identifier. The client-side presence application 32 may periodically or randomly cause presentation of the buddy presence notification 140. The client-side presence application 32 may even respond to a user input and present the buddy presence notification 140 when commanded.

Exemplary embodiments may be applied to instant messaging. When the client-side presence application 32 sends the presence notification 28, the presence notification 28 may report the channel 42 currently being received by the user's electronic device 20 (such as by a set-top box). The presence notification 28 may also include a user identification associated with the set-top box. When the server-side presence application 46 receives the presence notification 28, the server-side presence application 46 may query the presence database 50 and/or the buddy database 118 for the user's buddies and/or for their content. Here, though, exemplary embodiments may also associate or cross-reference user identifications to instant messaging identifications (or “IM IDs”). That is, exemplary embodiments may track one or many instant messaging accounts and cross-reference each buddy's content. The buddy presence notification 140, for example, may present the listing 124 of user identifications that are associated with the buddy roster 120. The buddy presence notification 140 may include each buddy's instant messaging identification. When the client-side presence application 32 visually and/or audibly presents the buddy presence notification 140, the user may see (and/or hear) each buddy's instant messaging ID. The user may then invoke or call an instant messaging application to send an instant message to any buddy.

Exemplary embodiments may also include privacy features. Some users may not want their content selection revealed to other users (even their buddies). Some users, for example, may not want the current channel (e.g., the PLAYBOY® channel) revealed. Some users may not want the title or other identifier of their content revealed. Some users may not want their content selections revealed to a particular person or “buddy.” Here, then, the client-side presence application 32 and/or the server-side presence application 46 may include privacy rules or features. FIG. 5, for example, illustrates a list 146 of exclusions. The list 146 of exclusions is illustrated as being locally stored in the user's electronic device 20, yet the list 146 of exclusions may be stored in the server 36. The list 146 of exclusions, however, may be remotely stored at some other node or location in the communications network 24. Regardless, the list 146 of exclusions may include channels, titles, applications, or other content identifiers that the user wishes to not be revealed. When the user makes a content selection, exemplary embodiments may then query the list 146 of exclusions for the content information 40. If the user's content selection matches an entry in the list 146 of exclusions, then the client-side presence application 32 may decline to send the presence notification 28. Or, if the presence notification 28 is sent, the presence notification 28 may fail to include information representing the current content (e.g., the content information 40, illustrate in FIG. 1). Or, if the presence notification 28 is sent, the presence notification 28 may include a flag, code, or other indicator that prevents the server-side presence application 46 from revealing the user's selected content. The user may configure the list 164 of exclusions to include any content information 40 that user wishes to conceal or screen, thus remaining hidden and/or unexposed.

The list 146 of exclusions may also include user IDs. Some users may not want their content selections revealed to a particular person or “buddy.” The list 146 of exclusions, then, may include names, user identifications, and/or or device identifiers for whom the user's content selections are not revealed. When the buddy roster is retrieved from the buddy database 118, exemplary embodiments may query the list 146 of exclusions for each buddy's user identification. If any buddy's user identification matches an entry in the list 146 of exclusions, then exemplary embodiments may conceal the user's content selection from that user identification.

The list 146 of exclusions may also include dates and/or times. Some users may want to conceal their content selections during particular days or even times of days. Some users may not want their late-night content selections revealed. Some users may not want their children's after-school content selections revealed. Whatever the reasons, the list 146 of exclusions may include dates and/or times of day for which content selections are not revealed. When the user makes a content selection, exemplary embodiments may note, tag, or otherwise associate the content section with a date and time. Exemplary embodiments may then query the list 146 of exclusions for the date and time. If the date and/or the time match an entry in the list 146 of exclusions, then exemplary embodiments may decline to send the presence notification 28. Or, if the presence notification 28 is sent, the presence notification 28 may include a flag, code, or other indicator that prevents the server-side presence application 46 from revealing the user's selected content.

Exemplary embodiments may also utilize clickstream data. The term “clickstream” describes a sequence of entries to a user interface (such as a keyboard or remote control). As the user makes content selections, for example, the sequence of keystrokes or buttons pushed may be used to identify the user's content selection, the user, the user's electronic device 20, and/or the user's buddies. The user's clickstream data, for example, may be used to identify the user, based on a recognized pattern match. Exemplary embodiments may store recurring patterns or sequences of clickstream data, and a match may identify the corresponding user or device. When the presence notification 28 is sent, the presence notification 28 may include information representing the user's clickstream data, and exemplary embodiments may at least partially reveal the clickstream data to the user's buddies. Clickstream data, however, is known to those of ordinary skill in the art and, thus, not discussed in detail. If the reader desires more details, the reader is invited to consult U.S. Pat. No. 6,983,478 to Grauch, et al. (Jan. 3, 2006) (Attorney Docket 95003 CON), which is incorporated herein by reference in its entirety.

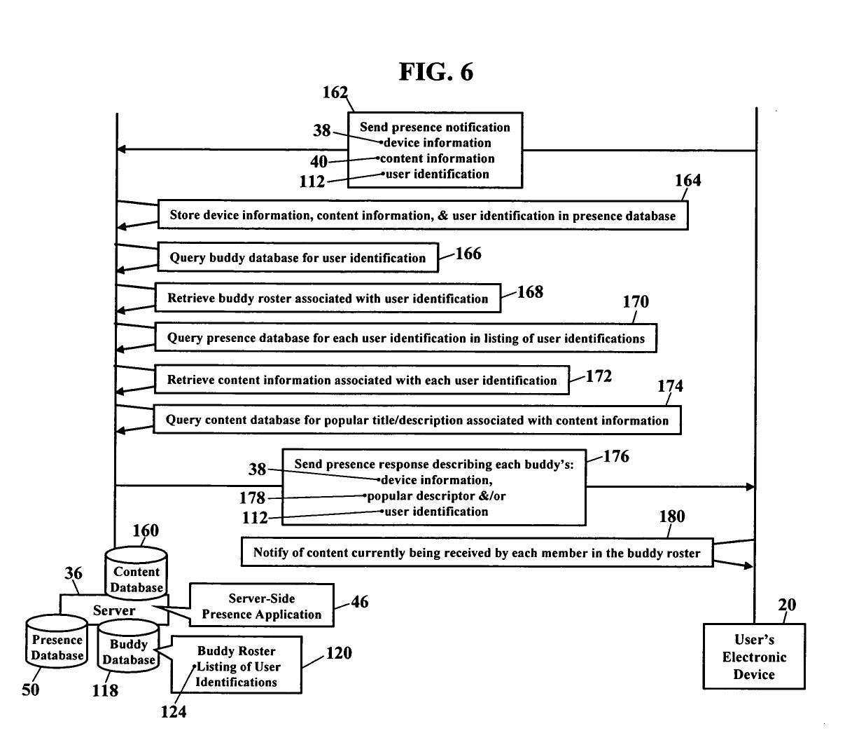

FIG. 6 is a schematic illustrating another process for sharing presence information, according to still more exemplary embodiments. Here a content database 160 may be queried for popular names or titles of content. The user's electronic device 20 sends the presence notification 28 (Block 162). When the server 36 receives the presence notification, the server-side presence application 46 stores the device information 38, the content information 40, and the user identification 112 in the presence database 50 (Block 164). The server-side presence application 46 may then query the buddy database 118 for the user identification 112 (Block 166). The server-side presence application 46 retrieves the buddy roster 120 associated with the user identification 112 (Block 168). The server-side presence application 46 queries the presence database 50 for each user identification in the buddy roster 120 (Block 170). The server-side presence application 46 retrieves the content information associated with each member in the buddy roster 120 (Block 172). The server-side presence application 46 now knows what content is currently being received by each buddy.

The server-side presence application 46 may now consult the content database 160. According to exemplary embodiments, the content database 160 maps or otherwise associates the content information 40 to popular names or titles. The content information 40, as earlier explained, may be a number or other alphanumeric sequence that uniquely describes the content being reported by a user. This alphanumeric sequence, however, may be meaningless to the general public. When, for example, the movie “TITANIC” is uniquely identified with the code “5415SGG485A,” that code would be unrecognizable to most, if not all, users. If the buddy presence notification (illustrated as reference numeral 140 in FIG. 5) lists a buddy's content as “5415SGG485A,” that code would not be meaningful to users. The server-side presence application 46, then, may query the content database 160 for the content information 40 (Block 174). The content database 160 translates the content information 40 into a more recognizable term, such as a title of the content. The content database 160, for example, associates “5415SGG485A” with “TITANIC.” While the content database 160 is illustrated as being locally stored in the server 36, the content database 160 may be remotely accessed via the communications network (illustrated as reference numeral 24 in FIG. 1). The server-side presence application 46 retrieves the popular name or title associated with the content information 40. The server-side presence application 46 may repeat this query for each member in the user's buddy roster.

A presence response, such as the presence response 142, is then sent (Block 176). The presence response 142 may include the device identification 38, the user identification 112, and/or a popular descriptor 178 associated with each member in the buddy roster. When the presence response is received, the client-side presence application 32 notifies of the content currently being received by each member in the user's buddy roster (Block 180). The user is once again informed of what content each buddy is currently receiving.

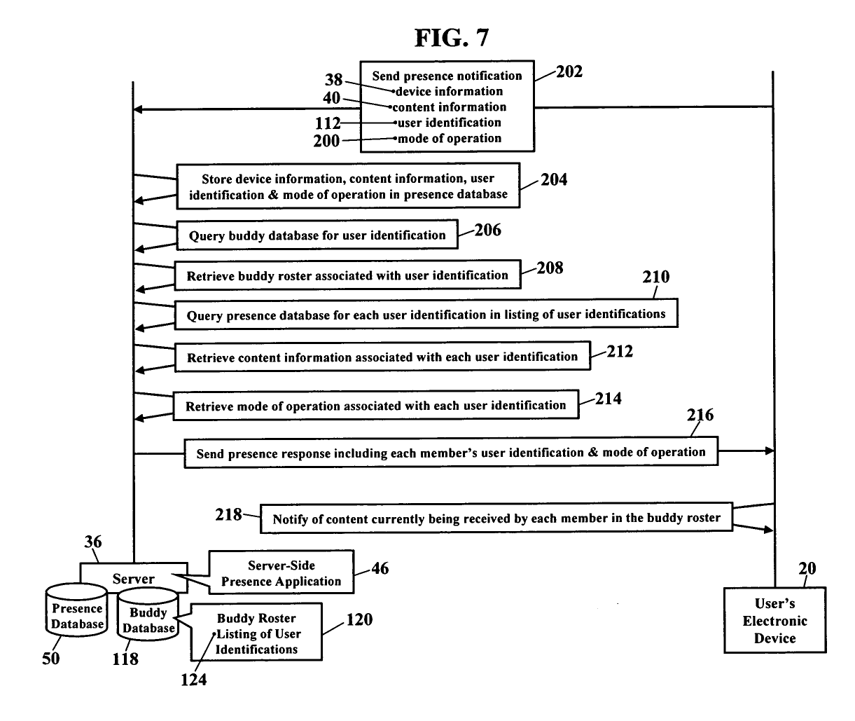

FIG. 7 is a schematic illustrating yet another process for sharing presence information, according to still more exemplary embodiments. Here the user's electronic device 20 may report a current mode 200 of operation associated with the device 20, and the user's buddies may be informed of the mode 200 of operation. When the user's electronic device 20 sends the presence notification 28 (Block 202), the presence notification 28 may include the device information 38, the content information 40, the user identification 112, and the mode 200 of operation of the device. The mode 200 of operation describes an operating state and/or setting of the user's electronic device 20. The presence notification 28, for example, may describe a recording mode of operation, when the user's electronic device 20 is recording media. If the user's electronic device 20 is receiving content from local memory (such as a local hard drive storing music, movies, and/or photos), the mode 200 of operation may indicate this local retrieval of content. If the user's electronic device 20 is executing, playing, or receiving content from a CD-ROM player, DVD player, analog or digital recorder, or other peripheral device, the mode 200 of operation may indicate the peripheral and even the content being played. When the user's electronic device 20 receives an over-the-air broadcast (such as broadcast television or radio), the mode 200 of operation may indicate this broadcast operation and a frequency or other identifier of the broadcast. When the user's electronic device 20 is executing a word processing application, browser application, or any other programming application, the mode 200 of operation may indicate a name or other identifier of this application.

When the server 36 receives the presence notification 28, the server 36 updates the presence database 50. The server-side presence application 46 stores the device information 38, the content information 40, the user identification 112, and/or the mode 200 of operation in the presence database 50 (Block 204). The server-side presence application 46 queries the buddy database 118 for the user identification 112 (Block 206). The buddy roster 120 associated with the user identification 112 is retrieved (Block 208). The presence database 50 is queried for each user identification in the buddy roster 120 (Block 210). The server-side presence application 46 retrieves the content information associated with each member in the buddy roster (Block 212). The server-side presence application 46 may also retrieve the mode of operation associated with each member (e.g., user identification) in the buddy roster 120 (Block 214). The presence response 142 is sent, and the presence response may include or describe each user's user identification 112 and each member's device's current mode of operation (Block 216). When the presence response 142 is received, the client-side presence application 32 notifies of the content currently being received by each member in the user's buddy roster and/or the current mode of operation for each buddy's device (Block 218). Buddies may thus know when other buddies are listening to broadcast radio, watching a DVD, or executing any other application.

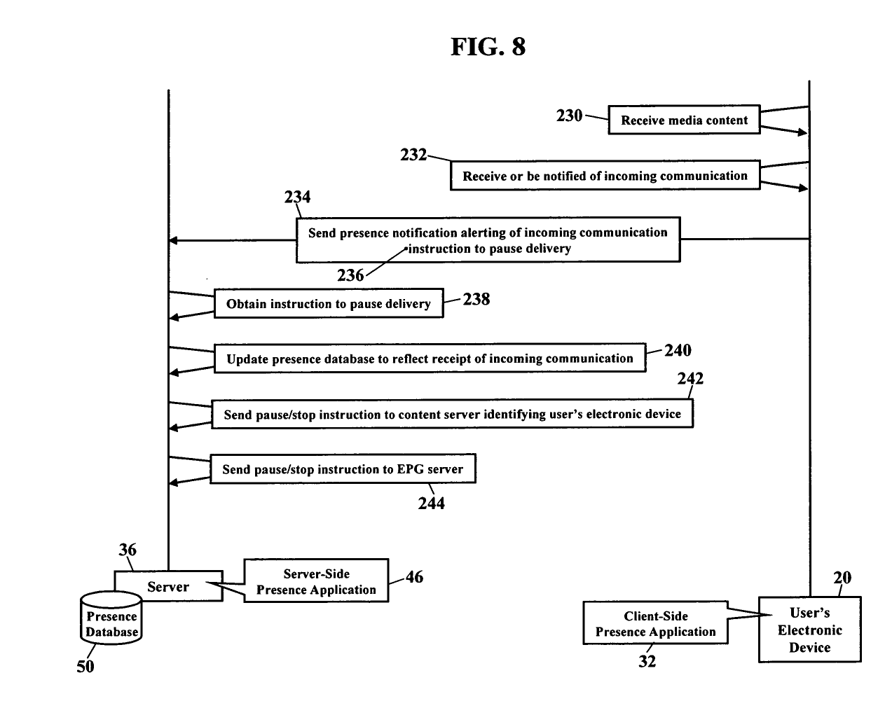

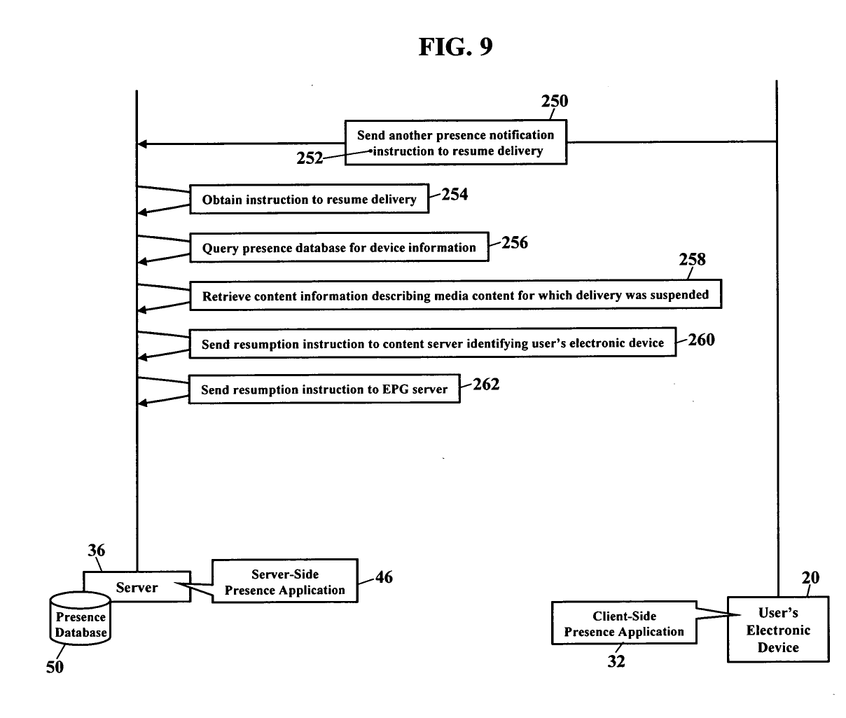

FIGS. 8 and 9 are schematics illustrating yet another process for sharing presence information, according to even more exemplary embodiments. Here, when the user's electronic device 20 reports an incoming communication, exemplary embodiments may pause delivery of media. As FIG. 8 illustrates, the user's electronic device 20 receives the media content 22 (via the communications network 24 shown in FIG. 1) (Block 230). While the media content 22 is being received, the user's electronic device 20 may receive, or is notified of, an incoming communication (Block 232). The incoming communication may be an incoming telephone call, email, instant message, or any other electronic communication or message. The incoming communication may originate from any user and/or device. When the incoming communication is received, the client-side presence application 32 may be configured to send the presence notification 28 to the server 36 (Block 234). The presence notification 28 includes information that alerts the server-side presence application 46 to the incoming communication. The presence notification 28, for example, may identify a type of incoming communication and a time of receipt of the incoming communication. The presence notification 28 may even identify a sending/originating party or address, if the user configures the presence notification 28 to reveal such information.

The presence notification 28 may also include an instruction 236 to pause delivery. When the client-side presence application 32 detects the incoming communication, the client-side presence application 32 may be configured to pause delivery of the media content 22. When, for example, the incoming communication is an incoming POTS or VoIP telephone call, the user may wish to pause or stop delivery of the media content 22. If the user cannot enjoy the media content 22 while conversing, the user may wish to pause or stop delivery. If the incoming communication is an email or instant message, the user may wish to pause delivery until a response is sent. The client-side presence application 32 may even be configured to pause delivery of the electronic programming guide 70. Whatever the reasons, when the incoming communication is received, the user may configure the client-side presence application 32 to pause delivery of the media content 22 and/or the electronic programming guide 70. The client-side presence application 32 sends the presence notification 28 including the instruction 236 to pause delivery.

When the server-side presence application 46 receives the presence notification 28, the server-side presence application 46 reads, retrieves, extracts, or otherwise obtains the instruction 236 to pause delivery (Block 238). The server-side presence application 46 then updates the presence database 50 to reflect the receipt of the incoming communication (Block 240). The server-side presence application 46, for example, may store the type of incoming communication and the time of receipt of the incoming communication. If the presence notification 28 identifies the sending/originating party or address, then the server-side presence application 46 may also store this information in the presence database 50. (The server-side presence application 46 may also store the device information 38, the content identifier 40, the user identification 112, and/or the mode 200 of operation, as previously explained.) The presence database 50 may thus updated to reflect a comprehensive view of the user's content, mode of operation, and communications status.

The server-side presence application 46 may then stop delivery. The server-side presence application 46, for example, may send a pause/stop instruction to the content server (illustrated as reference numeral 26 in FIG. 1) (Block 242). The pause/stop instruction may identify the user's electronic device 20, such as by the device information 38, the content information 40, and/or the user identification 112 (illustrated, respectively, as reference numerals 38, 40, and 112 in FIGS. 1 and 4). When the content server 26 receives the pause/stop instruction, the content server 26 halts, suspends, pauses, or otherwise stops sending the media content 22. The content server 26 may even store or maintain a pointer or other notation that indicates a point in the media content 22 at which delivery is suspended. The server-side presence application 46 may also send the pause/stop instruction to the EPG server (illustrated as reference numeral 82 in FIG. 3) (Block 244). The pause/stop instruction may cause the electronic programming guide application (illustrated as reference numeral 72 in FIGS. 1 and 3) to halt, suspend, pause, or otherwise stop sending the electronic programming guide 70 to the user's electronic device 20. The electronic programming guide application 72 may also store or maintain a pointer or other notation that indicates a point in the electronic programming guide 70 at which delivery is suspended. The server-side presence application 46, in other words, opens up any communications link between the communications network and the user's electronic device 20, according to exemplary embodiments. The server-side presence application 46 may stop delivery of content that is not necessary to receive and/or respond to the incoming communication. By stopping delivery of the media content 22 and/or the electronic programming guide 70, the server-side presence application 46 also reduces the workload on the user's electronic device 20.

FIG. 9 illustrates resumption of delivery. The server-side presence application 46 may automatically resume delivery of the media content 22 and/or the electronic programming guide 70. When the user responds to the incoming communication, completes a telephone call, and/or otherwise commands, another presence notification is sent (Block 250). This another presence notification may include an instruction 252 to resume delivery. The server-side presence application 46 reads, retrieves, extracts, or otherwise obtains the instruction 252 to resume delivery (Block 254). The server-side presence application 46 may then query the presence database 50 for the device information 38 (Block 256). The server-side presence application 46 retrieves the content information 40 describing the media content 22 for which delivery was suspended (Block 258). The server-side presence application 46 then sends a resumption instruction to the content server 26 (Block 260). The resumption instruction may identify the user's electronic device 20 (such as by the device information 38, the content information 40, and/or the user identification 112). When the content server 26 receives the resumption instruction, the content server 26 resumes sending the media content 22 (perhaps from the pointer, as explained above). The server-side presence application 46 may also send the resumption instruction to the EPG server 36 (Block 262). The resumption instruction may cause the electronic programming guide application 72 to resume sending the electronic programming guide 70 to the user's electronic device 20 (perhaps from the pointer, as explained above). The user's electronic device 20 thus resumes receiving the media content 22 and/or the electronic programming guide 70.

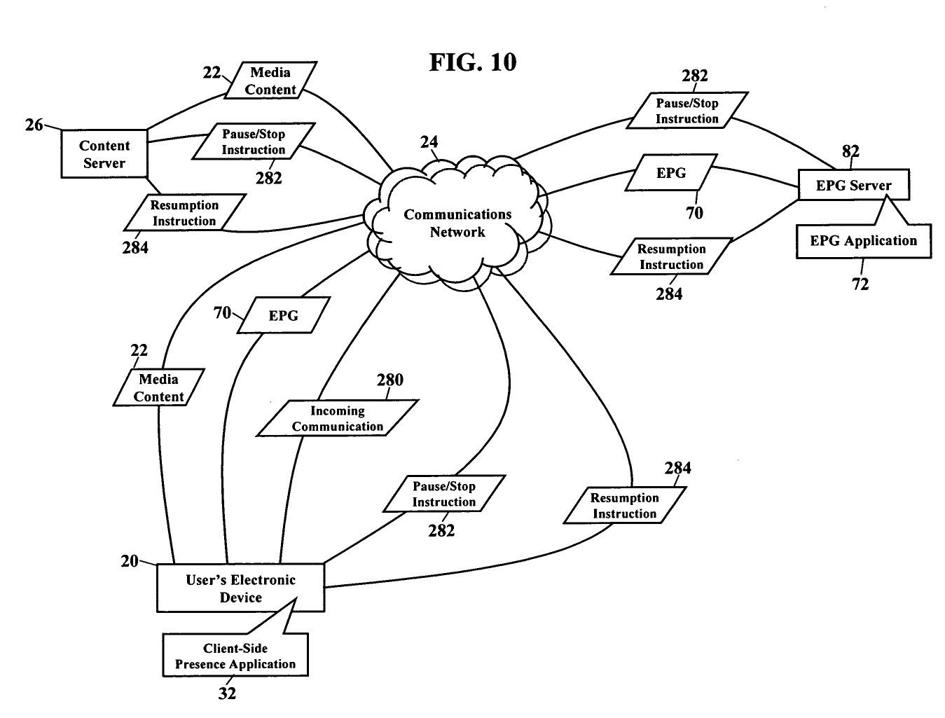

FIG. 10 is a schematic further illustrating presence information, according to even more exemplary embodiments. Here the client-side presence application 32 may directly inform the content server 26 and/or the EPG server 82 of an incoming communication 280. While the user's electronic device 20 is receiving the media content 22, the user's electronic device 20 also receives, or is notified of, the incoming communication 280. When the client-side presence application 32 detects the incoming communication 280, the client-side presence application 32 sends a pause/stop instruction 282. Here, however, the pause/stop instruction 282 is sent to the content server 26 and/or to the EPG server 82. The client-side presence application 32 may even self-notate a time or other marker to indicate at what point delivery is stopped. When the content server 26 receives the pause/stop instruction 282, the content server 26 stops sending the media content 22. The pause/stop instruction 282 may also cause the electronic programming guide application 72 to stop sending the electronic programming guide 70 to the user's electronic device 20. The client-side presence application 32 thus again opens up the communications link with the communications network 24 and reduces the workload on the user's electronic device 20.

The client-side presence application 32 may also automatically resume delivery. When the user responds to the incoming communication, and/or completes a telephone call, the client-side presence application 32 sends a resumption instruction 284 to resume delivery. The resumption instruction 284 may describe the user's electronic device 20 for which delivery was suspended. The resumption instruction 284 may also include a pointer or other marker to indicate from when or from where the media content 22 should be resumed. The resumption instruction 284 may be sent to the content server 26, thus causing the content server 26 to resume sending the media content 22. When the resumption instruction 284 is sent to the EPG server 82, the resumption instruction 284 may cause the electronic programming guide application 72 to resume sending the electronic programming guide 70 to the user's electronic device 20. The user's electronic device 20 thus resumes receiving the media content 22 and/or the electronic programming guide 70.

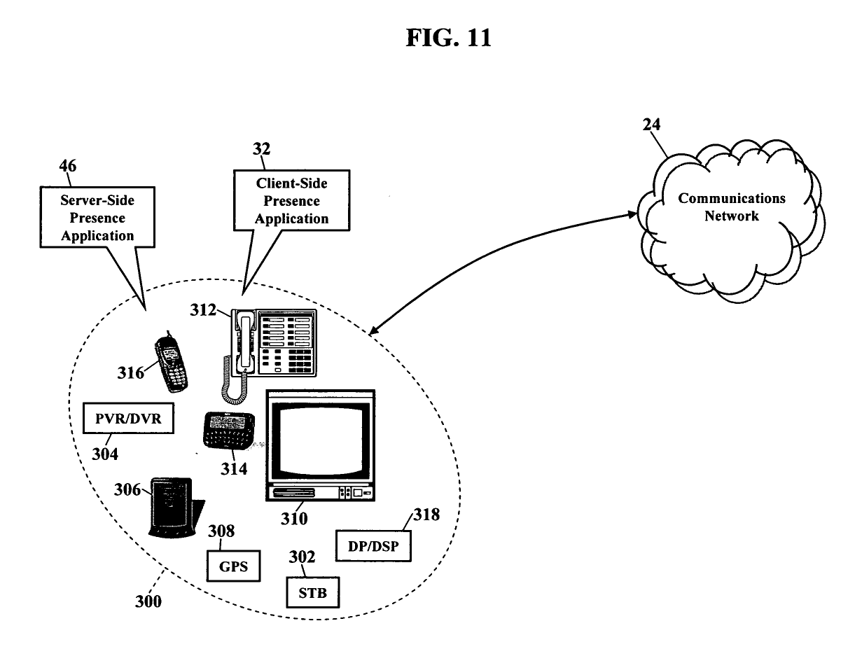

FIG. 11 depicts other possible operating environments, according to more exemplary embodiments. FIG. 11 illustrates that the client-side presence application 32 and/or the server-side presence application 46 may alternatively or additionally operate within various other communications devices 300. FIG. 11, for example, illustrates that the client-side presence application 32 and/or the server-side presence application 46 may entirely or partially operate within a set-top box (302), a personal/digital video recorder (PVR/DVR) 304, personal digital assistant (PDA) 306, a Global Positioning System (GPS) device 308, an interactive television 310, an Internet Protocol (IP) phone 312, a pager 314, a cellular/satellite phone 316, or any computer system and/or communications device utilizing a digital processor or digital signal processor (DP/DSP) 318. The communications device 300 may also include watches, radios, vehicle electronics, clocks, printers, gateways, and other apparatuses and systems. Because the architecture and operating principles of the various communications devices 300 are well known, the hardware and software components of the various communications devices 300 are not further shown and described. If, however, the reader desires more details, the reader is invited to consult the following sources: LAWRENCE HARTE et al., GSM SUPERPHONES (1999); SIEGMUND REDL et al., GSM AND PERSONAL COMMUNICATIONS HANDBOOK (1998); and JOACHIM TISAL, GSM CELLULAR RADIO TELEPHONY (1997); the GSM Standard 2.17, formally known Subscriber Identity Modules, Functional Characteristics (GSM 02.17 V3.2.0 (1995-01))”; the GSM Standard 11.11, formally known as Specification of the Subscriber Identity Module—Mobile Equipment (Subscriber Identity Module—ME) interface (GSM 11.11 V5.3.0 (1996-07))”; MICHEAL ROBIN & MICHEL POULIN, DIGITAL TELEVISION FUNDAMENTALS (2000); JERRY WHITAKER AND BLAIR BENSON, VIDEO AND TELEVISION ENGINEERING (2003); JERRY WHITAKER, DTV HANDBOOK (2001); JERRY WHITAKER, DTV: THE REVOLUTION IN ELECTRONIC IMAGING (1998); and EDWARD M. SCHWALB, ITV HANDBOOK: TECHNOLOGIES AND STANDARDS (2004).

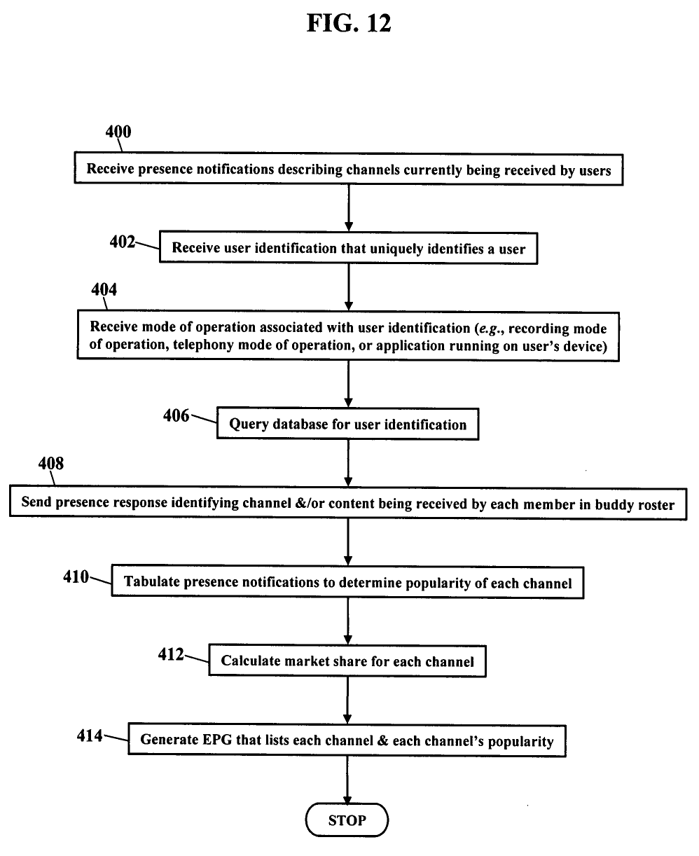

FIG. 12 is a flowchart illustrating a method for presence information, according to more exemplary embodiments. Presence notifications are received from users, and the presence notifications describe channels currently being received by the users (Block 400). The presence notifications may also include a user identification that uniquely identifies a user (Block 402). The presence notifications may also include a mode of operation for a device associated with the user identification, such as a recording mode of operation, a telephony mode of operation, and an application running on the device (Block 404). A database is queried for the user identification (Block 406). The database associates the user identification to members in a buddy roster and to content currently being received by each member in the buddy roster. A presence response may be sent that identifies the channel and/or content being received by each member in the buddy roster (Block 408). The presence notifications are tabulated to determine a popularity of each channel (Block 410). A market share for each channel may be calculated (Block 412). An electronic programming guide is generated that lists each channel and each channel's popularity (Block 414).

The client-side presence application 32, the server-side presence application 46, and/or the electronic programming guide application 72 may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-subscribers, licensees, and assignees. These types of computer-readable media, and other types not mention here but considered within the scope of the exemplary embodiments, allow easier dissemination of exemplary embodiments. A computer program product comprises the client- side presence application 32, the server-side presence application 46, and/or the electronic programming guide application 72 stored on the computer-readable medium.

Exemplary embodiments may be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol mobile phone, or a wireless pager.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method for sharing presence information, comprising:
receiving presence notifications from users, the presence notifications describing content items currently being received by the users;
determining a popularity of one or more of the content items being received by the users; and
providing an electronic programming guide that includes information regarding the one or more of the content items and the determined popularity associated with the one or more of the content items.

2. The method according to claim 1, wherein receiving the presence notification further comprises receiving a user identification that uniquely identifies a user.

3. The method according to claim 2, further comprising:
querying a database for the user identification, the database associating the user identification to members in a buddy roster and to content items currently being received by each member in the buddy roster; and
sending a presence response that identifies the content items being received by each member in the buddy roster.

4. The method according to claim 3, wherein sending the presence response comprises sending a channel currently being received by each member in the buddy roster.

5. The method according to claim 3, wherein sending the presence response comprises sending a mode of operation for a device associated with the user identification.

6. The method according to claim 5, wherein sending the mode of operation comprises sending at least one of a recording mode of operation, a telephony mode of operation, and an application running on the device.

7. The method according to claim 3, further comprising sending an instant messaging identification associated with a member in the buddy roster.

8. The method according to claim 1, wherein determining a popularity comprises calculating a market share for the one or more of the content items.

9. A system operative to:
receive presence notifications from users, the presence notifications describing content items currently being received by the users;
determine a popularity of one or more of the content items being received by the users; and
provide an electronic programming guide that includes information regarding the one or more of the content items and the determined popularity associated with the one or more of the content items.

10. The system according to claim 9, further operative to receive a user identification that uniquely identifies a user.

11. The system according to claim 10, further operative to:
query a presence database for the user identification, the presence database associating the user identification to members in a buddy roster and to content items currently being received by each member in the buddy roster; and
send a presence response that identifies the content items being received by each member in the buddy roster.

12. The system according to claim 11, further operative to send a channel currently being received by each member in the buddy roster.

13. The system according to claim 11, further operative to send a mode of operation for a device associated with the user identification.

14. The system according to claim 13, further operative to send at least one of a recording mode of operation, a telephony mode of operation, and an application running on the device.

15. The system according to claim 10, further operative to calculate a market share for the one or more of the content items.

16. A computer program product storing processor-executable code for performing a method, the method comprising:
receiving presence notifications from users, the presence notifications describing content items currently being received by the users;
determining a popularity of one or more of the content items being received by the users; and
providing an electronic programming guide that includes information regarding the one or more of the content items and the determined popularity associated with the one or more of the content items.

17. A computer program product according to claim 16, further comprising computer code for receiving a user identification that uniquely identifies a user.

18. A computer program product according to claim 17, further comprising computer code for:
querying a database for the user identification, the database associating the user identification to members in a buddy roster and to content items currently being received by each member in the buddy roster; and
sending a presence response that identifies the content items being received by each member in the buddy roster.

19. A computer program product according to claim 18, further comprising computer code for sending a channel currently being received by each member in the buddy roster.

20. A computer program product according to claim 18, further comprising computer code for sending a mode of operation for a device associated with the user identification.
